(19) United States
(12) Patent Application Publication
(10) Pub. No.: US 2013/0341161 A1
(43) Pub. Date: Dec. 26, 2013

(54) TRANSMISSION DEVICE

(71) Applicant: HON HAI PRECISION INDUSTRY CO., LTD., New Taipei (TW)

(72) Inventor: CHUN-I WU, New Taipei (TW)

(73) Assignee: HON HAI PRECISION INDUSTRY CO., LTD., New Taipei (TW)

(21) Appl. No.: 13/851,105

(22) Filed: Mar. 27, 2013

(30) Foreign Application Priority Data
Jun. 20, 2012 (TW) 101122121

(51) Int. Cl. B65G 13/02

(52) U.S. Cl. CPC B65G 13/02
USPC 198/789

(57) ABSTRACT

A transmission device includes a first bracket, a second bracket, a slave wheel, a rotating shaft, a paper pressing assembly, and a pivoting shaft. The rotating shaft is rotatably mounted between the first bracket and the second bracket. The slave wheel is secured to the shaft. The pressing assembly includes a pressing member and a pressing wheel secured to the pressing member. The pressing member is secured to the pivoting shaft. The pivoting shaft is pivotably mounted between the first bracket and the second bracket. The pivoting shaft is rotatable relative to the rotating shaft together with the pressing member and the pressing wheel. Thus, a distance between the pressing wheel and the slave wheel is expanded to let a paper pass between the pressing wheel and the slave wheel, so that the paper will not be jammed or badly printed.

### BACKGROUND

1. Technical Field

The present disclosure relates to transmission devices, and particularly to a transmission device for a sprayer in an inkjet printer.

2. Description of Related Art

When paper is printed in an inkjet printer, the paper is pulled from a drive module to a slave module. The slave module includes a slave wheel and a paper pressing assembly. The paper pressing assembly includes a pressing arm and a pressing wheel secured to the pressing arm. The paper is slid smoothly between the slave wheel and the pressing wheel from the driving module. However, because a position of the pressing arm is fixed, an angle between the slave wheel and the pressing wheel is limited. When an end of the paper is slid between the slave wheel and the pressing wheel, the end of the paper is easily raised to touch a sprayer of the printer or the paper pressing assembly, and the paper may jam or be badly printed. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a transmission device.

FIG. 2 is an assembled, isometric view of a pressing member and a pressing wheel of FIG. 1, but viewed from a different aspect.

FIG. 3 is an assembled, isometric view of the transmission device of FIG. 1, shown with a paper pressing assembly at an initial position.

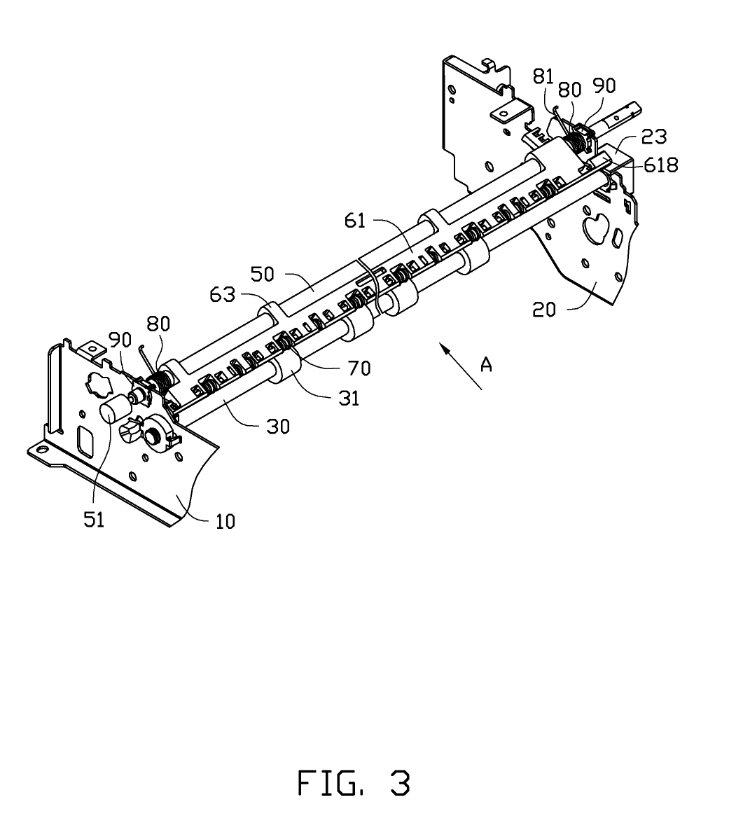

FIG. 4 is similar to FIG. 3, but shown with the paper pressing assembly in an open position.

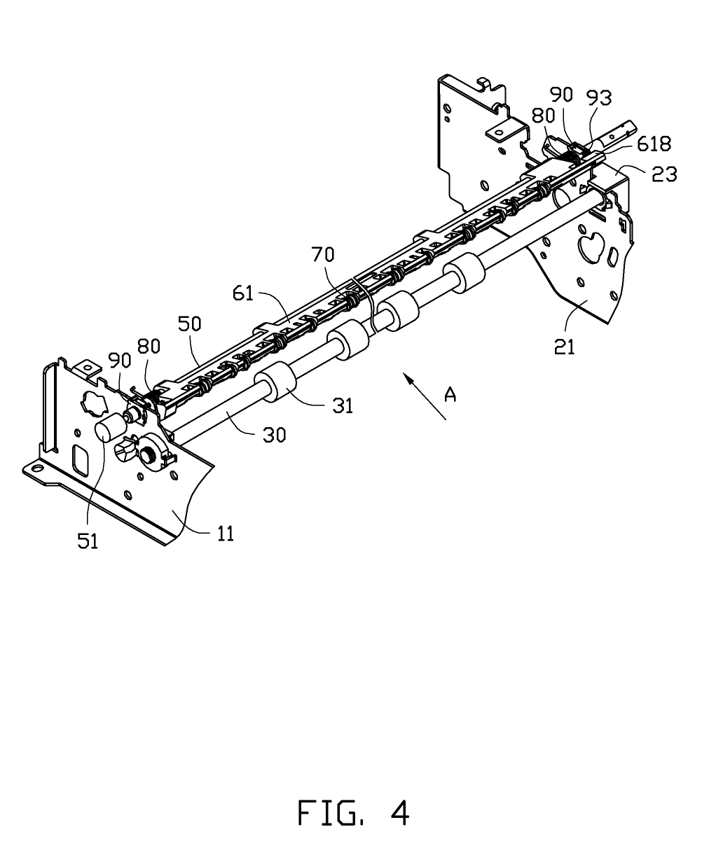

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

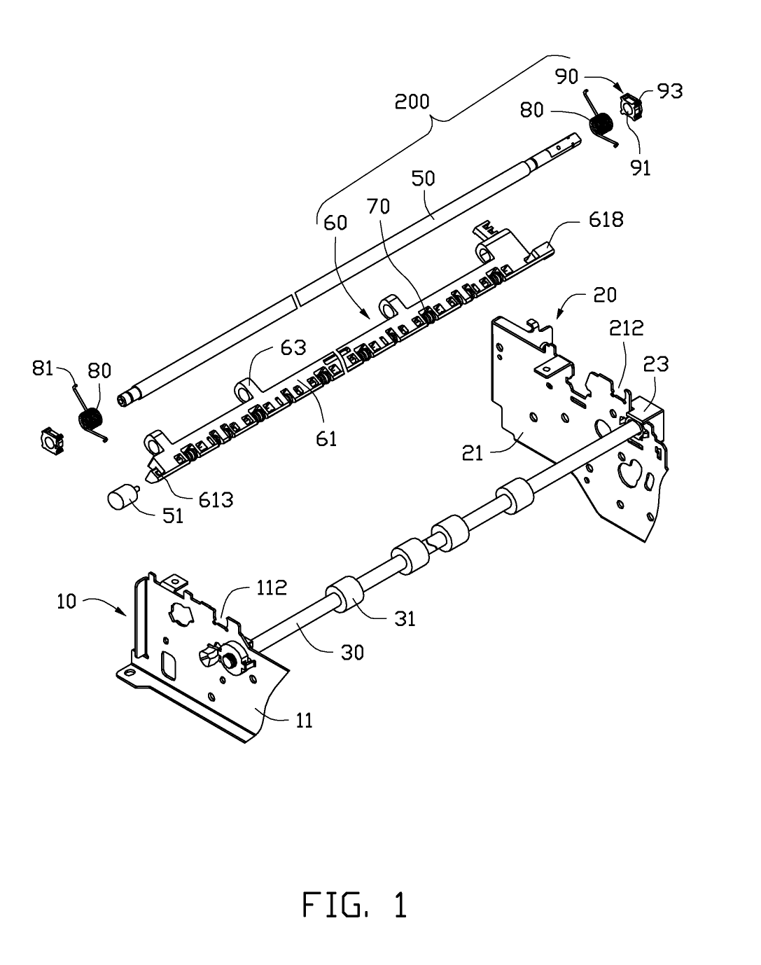

FIG. 1 shows a transmission device in accordance with an embodiment. The transmission device includes a first bracket 10, a second bracket 20, a rotating shaft 30, a plurality of slave wheels 31 secured to the rotating shaft 30, and a paper pressing assembly 200.

The first bracket 10 includes a first mounting plate 11. The first mounting plate 11 defines a mounting slot 112. In one embodiment, the first mounting plate 11 is substantially perpendicular to a horizontal plane.

The second bracket 20 includes a second mounting plate 21 and a limiting piece 23 extending from a top edge of the second mounting plate 21. The second mounting plate 21 defines a second mounting slot 212. In one embodiment, the second mounting plate 21 is substantially parallel to the first mounting plate 11, and the limiting piece 23 is substantially perpendicular to the second mounting plate 21.

A first end of the rotating shaft 30 is rotatably secured to the first mounting plate 11. A second end of the rotating shaft 30 is rotatably secured to the second mounting plate 21 and located under the limiting piece 23.

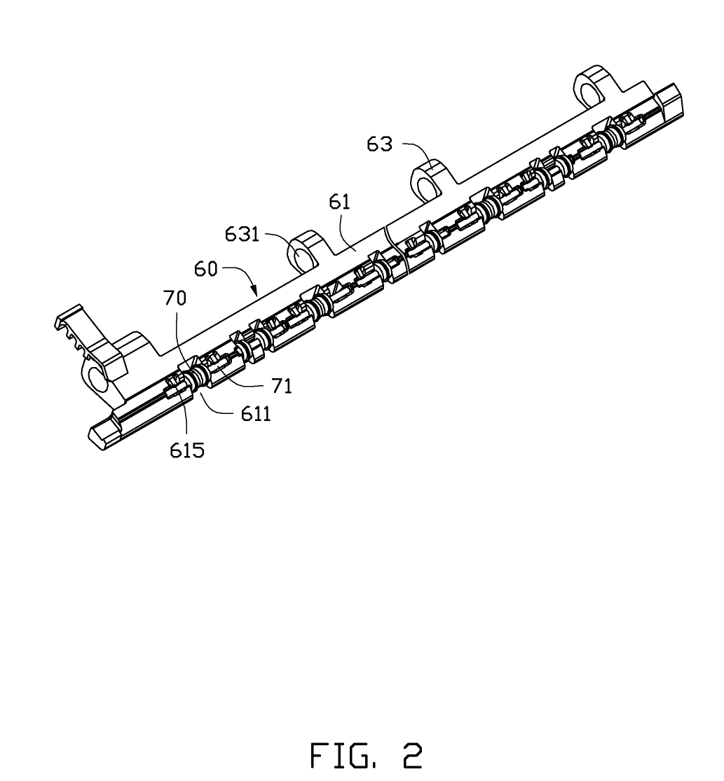

FIG. 1 and FIG. 2 show the paper pressing assembly 200 which includes a pivoting shaft 50, two springs 80, two mounting members 90, a pressing member 60, and a plurality of pressing wheels 70 secured to the pressing member 60.

The pivoting shaft 50 can be horizontal columnar. An end of the pivoting shaft 50 secures a motor 51. The motor 51 is operable to rotate the pivoting shaft 50.

The pressing member 60 includes a pressing arm 61 and a plurality of pivoting portions 63 extending from a side of the pressing arm 61. The pressing arm 61 defines a plurality of receiving slots 611 and a plurality of mounting slots (not labeled). Each receiving slot 611 can receive one of the pressing wheels 70, and the mounting slots can receive a mounting shaft 71, which secures the plurality of pressing wheels 70. An extending direction of each receiving slot 611 is substantially perpendicular to an extending direction of each mounting slot. A plurality of limiting blocks 615 extend from the pressing arm 61, and each limiting block 615 is located in one of the mounting slots of the pressing arm 61. The pressing arm 61 defines an installation slot 613 in each of two opposite ends. Each pressing wheel 70 is received in each receiving slot 611. Each limiting block 615 abuts the mounting shaft 71 and blocks the mounting shaft 71 in the mounting slot of the pressing arm 61. Each pivoting portion 63 defines a pivoting hole 631. A resisting portion 618 is located in an end of the pressing arm 61. The resisting portion 618 can abut the limiting piece 23 to prevent the pressing arm 61 from overly rotating. In one embodiment, the installation slot 613 is “L” shaped.

Each spring 80 is a torsion spring and includes two “L” shaped installation ends 81.

Each mounting member 90 defines a receiving hole 91 for securing the pivoting shaft 50 to the first bracket 10 and the second bracket 20. A limiting portion 93 extends obliquely outwards from each of four corners of each mounting member 90.

FIG. 1 and FIG. 2 show that in assembly, the pivoting shaft 50 is aligned with the pivoting hole 631. The pivoting shaft 50 is inserted through each pivoting hole 631 to engage with the pressing member 60. The pivoting shaft 50 can be rotated together with the pressing member 60. Each spring 80 is engaged with each of opposite ends of the pivoting shaft 50, and one of the two installation ends 81 of each spring 80 is engaged in each installation slot 613. The two mounting members 90 are engaged with opposite ends of the pivoting shaft 50, and the pivoting shaft 50 is rotatable relative to the two mounting members 90. The paper pressing assembly 200 is assembled.

The paper pressing assembly 200 is moved to adjacent to the slave wheel 31 and located above the slave wheel 31. The pivoting shaft 50 is moved to be parallel to the rotating shaft 30. The other installation ends 81 of the two springs 80 is secured to the first mounting plate 11 and the second mounting plate 21. The two mounting members 90 are each engaged in the first mounting slot 112 and the second mounting slot 212. The two limiting portions 93 of the two mounting members 90 each extend out of the first mounting slot 112 and the second mounting slot 212. The resisting portion 618 abuts the limiting piece 23. The paper pressing assembly 200 is rotatably mounted to the first bracket 10 and the second bracket 20. In this position, the pressing arm 61 and each spring 80 is located in an initial position. A first distance is defined between the slave wheel 31 and the pressing wheel 70.

In use, a paper is slid from a driving module (not shown) to the slave wheel 31 along a direction A. Before the paper arrives at the slave wheel 31, the motor 51 rotates the pivoting shaft 50 along a first direction away from the slave wheel 31. The pivoting shaft 50 resists the pressing member 60 and the pressing wheel 70 allowing rotation along the first direction to elastically deform the two springs 80. In this position, the pressing arm 61 is located in an open position, and a second distance is defined between the slave wheel 31 and the pressing wheel 70. The second distance is greater than the first distance. The paper is slid between the slave wheel 31 and the pressing wheel 70, and an end of the paper abuts the slave wheel 31. In this position, the motor 51 is stopped. The two springs 80 rebound to rotate the pressing member 60 along a second direction, which is opposite to the first direction, until the resisting portion 618 abuts the limiting piece 23. In this position, the two springs 80 and the pressing member 60 are in the initial position. The pressing wheel 70 presses the paper, so that the paper can slide smoothly over the slave wheel 31.

The limiting portion 90 is used for abutting the resisting portion 618 when the pivoting shaft 50 is rotated, to prevent the pressing arm 61 from overly rotating.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A transmission device comprising:
a first bracket;
a second bracket;
a rotating shaft rotatably mounted between the first bracket and the second bracket;
a pivoting shaft pivotably mounted between the first bracket and the second bracket;
a slave wheel secured to the shaft; and
a paper pressing assembly comprising a pressing member and a pressing wheel secured to the pressing member;
wherein the pressing member is secured to the pivoting shaft; and the pivoting shaft is rotatable relative to the rotating shaft together with the pressing member and the pressing wheel.

2. The transmission device of claim 1, wherein the pivoting shaft is substantially parallel to the pivoting shaft.

3. The transmission device of claim 1, wherein the pressing member is rotatable between an initial position and an open position; when the pressing member is in the initial position, a first distance is defined between the pressing wheel and the slave wheel; when the pressing member is in the open position, a second distance is defined between the pressing wheel and the slave wheel, and the second distance is greater than the first distance.

4. The transmission device of claim 1, wherein the pressing member comprises a pressing arm and pivoting portion extending from the pressing arm, the pivoting portion defines a pivoting hole, and the pivoting shaft is engaged in the pivoting hole.

5. The transmission device of claim 4, wherein the paper pressing assembly further comprises a spring, the pressing arm defines an installation slot, a first end of the spring is engaged in the installation slot, and a second end of the spring is engaged with the first bracket or the second bracket.

6. The transmission device of claim 5, wherein the spring is elastically deformed when the pressing member is rotated from the initial position to the open position, and the spring biases the pressing member to rotate from the open position to the initial position when rebounding.

7. The transmission device of claim 5, wherein the spring is a torsion spring.

8. The transmission device of claim 4, wherein the first bracket comprises a first mounting plate, and the second bracket comprises a second mounting plate and a limiting piece extending from the second mounting plate; the rotating shaft is rotatably mounted to the first mounting plate and the second mounting plate; the pressing member further comprises a resisting portion extending from the pressing arm; when the pressing member is in the initial position, the resisting portion abuts the limiting piece, and when the pressing member is in the open position, the resisting portion disengages from the limiting piece.

9. The transmission device of claim 8, wherein the first mounting plate is substantially parallel to the second mounting plate, and the limiting piece is substantially perpendicular to the second mounting plate and located above the rotating shaft.

10. The transmission device of claim 8, wherein the paper pressing assembly further comprises a mounting member, a mounting slot is defined in the first bracket or the second bracket, and the mounting member is engaged with the pivoting shaft and engaged in the mounting slot; and the pivoting shaft is rotatable relative to the mounting member.

11. A transmission device comprising:
a first bracket;
a second bracket;
a rotating shaft rotatably mounted between the first bracket and the second bracket;
a pivoting shaft pivotably mounted between the first bracket and the second bracket;
a slave wheel secured to the shaft; and
a paper pressing assembly comprising a pressing member secured to the pivoting shaft and a pressing wheel secured to the pressing member;
wherein the pivoting shaft is pivotable relative to the rotating shaft together with the pressing member and the pressing wheel; the pressing member is rotatable relative to the slave wheel between an initial position and an open position; when the pressing member is in the initial position, a first distance is defined between the pressing wheel and the slave wheel; when the pressing member is in the open position, a second distance is defined between the pressing wheel and the slave wheel, and the second distance is greater than the first distance.

12. The transmission device of claim 11, wherein the pivoting shaft is substantially parallel to the pivoting shaft.

13. The transmission device of claim 11, wherein the pressing member comprises a pressing arm and pivoting portion extending from the pressing arm, the pivoting portion defines a pivoting hole, and the pivoting shaft is engaged in the pivoting hole.

14. The transmission device of claim 13, wherein the paper pressing assembly further comprises a spring, the pressing arm defines an installation slot, a first end of the spring is engaged in the installation slot, and a second end of the spring is engaged with the first bracket or the second bracket.

15. The transmission device of claim 14, wherein the spring is elastically deformed when the pressing member is rotated from the initial position to the open position, and the spring biases the pressing member to rotate from the open position to the initial position when rebounding.

16. The transmission device of claim 14, wherein the spring is a torsion spring.

17. The transmission device of claim 13, wherein the first bracket comprises a first mounting plate, and the second bracket comprises a second mounting plate and a limiting piece extending from the second mounting plate; the rotating shaft is rotatably mounted to the first mounting plate and the second mounting plate.

18. The transmission device of claim 17, wherein the pressing member further comprises a resisting portion extending from the pressing arm; when the pressing member is in the initial position, the resisting portion abuts the limiting piece, and when the pressing member is in the open position, the resisting portion disengages from the limiting piece.

19. The transmission device of claim 18, wherein the first mounting plate is substantially parallel to the second mounting plate, and the limiting piece is substantially perpendicular to the second mounting plate and located above the rotating shaft.

20. The transmission device of claim 18, wherein the paper pressing assembly further comprises a mounting member, a mounting slot is defined in the first bracket or the second bracket, and the mounting member is engaged with the pivoting shaft and engaged in the mounting slot; and the pivoting shaft is rotatable relative to the mounting member.
